(19) United States
(12) Patent Application Publication
(10) Pub. No.: US 2006/0210007 A1
(43) Pub. Date: Sep. 21, 2006

(54) Floating scanning and detection platforms

(76) Inventors: Markku Koskelo, Middletown, CT (US); Yakov Shadyavichyus, Clarksburg, MD (US)

Correspondence Address: CARSTENS & CAHOON, LLP, P O BOX 802334, DALLAS, TX, 75380, US

(21) Appl. No.: 11/082,433

(22) Filed: Mar. 17, 2005

(51) Int. Cl. G21G 1/00

(52) U.S. Cl. 376/156

(57) ABSTRACT

The present invention provides a system for detecting explosives, drugs or radioactive or fissile material aboard waterborne vessels. The system includes a linear accelerator mounted on a floating platform such as a ship that directs a photon beam at a target vessel. If the target vessel contains explosives, drugs or radioactive or fissile material the photon beam will induce characteristic neutron radiation from these substances that is picked up by neutron radiation detectors mounted on the floating platform. Neutron radiation induced by the accelerator is detectable even through shielding such as lead. A floatation stabilization system supports the operation of the accelerator and detectors. A data storage system documents radiation data and corresponding identification data for the target vessel and can access a database containing the target vessels cargo manifest. Video cameras may be used to identify the target vessel. The radiation and identification data can be sent in near real time to the appropriate authorities via secure data transmission.

### CROSS-REFERENCE TO RELATED APPLICATION

This application claims the benefit of and priority to a U.S. patent application Ser. No. ______ filed Mar. 3, 2005, entitled “Floating Scanning and Detection Platforms”. The technical disclosure of which is hereby incorporated herein by reference.

### TECHNICAL FIELD

The present invention relates specifically to radiation detectors, and more specifically to floating detection platforms that are equipped to remotely detect special nuclear material, explosives and/or drugs aboard vessels.

### BACKGROUND OF THE INVENTION

With the growing threat of international terrorism, both governments and private firms are placing greater emphasis on security. In addition, the prospect of nuclear proliferation has increased the likelihood of terrorist or criminal organizations smuggling special nuclear materials or radioactive materials in combination with explosives into the country.

Smuggling via seaborne shipping vessels presents a particular problem due to the shear volume of seaborne shipping and the present limited ability to inspect all of these shipments. Of the 7-9 million plus cargo containers brought into the U.S. by boat each year less than 5% are inspected. This represents a hole in security through which a nuclear device or fissile material may be smuggled with a high probability of success.

Several solutions have been proposed to deal with this growing security threat. Most of these solutions center on the standard dockside unloading and inspection process. One such solution incorporates a radiation detector directly into a crane hoist attachment that is in physical contact with cargo containers as they are loaded and unloaded to and from ships. A similar solution incorporates an x-ray scanner into the frame of a crane. As cargo containers are lowered to the dock, they pass through the scanner beam. The advantage of these systems is that the inspection for nuclear devices and other radioactive material occurs as part of the loading and unloading process, allowing for inspection of all incoming and outgoing cargo.

However, the major disadvantage of these approaches is that they cannot detect the special nuclear materials associated with nuclear devices or other radioactive materials that might be used as a radiological dispersion device (RDD) or “dirty bomb” until it is already at dockside. In a worst case scenario, a nuclear device or RDD could still reach the port and be detonated; destroying the port and affecting the adjacent land area.

Another prior art solution to nuclear detection occurs at sea. This solution requires the manual placement of a plurality of radiation detectors directly into or onto cargo containers, which may not allow complete inspection of all containers due to time and manpower constraints. However, this solution potentially allows detection before any radioactive material reaches port. The purpose of inspecting at sea is to allow sufficient time to inspect the cargo containers before they reach port due to the long transit time of sea transport.

Another problem is the presence of shielding to prevent detection of radioactivity. Prior art solutions to this problem comprise weighing the containers (i.e. with a crane hoist) to determine if they are carrying heavy shielding (i.e. lead). However, this adds an additional process to the detection procedure and is only an indirect method, which may be affected by numerous factors.

Therefore, it would be desirable to have a method and system for detecting both shielded and unshielded radioactive material aboard seaborne cargo vessels while the cargo is still at sea, wherein detection does not require the manual inspection of each cargo container.

### SUMMARY OF THE INVENTION

The present invention provides a system for detecting special nuclear materials used in nuclear devices and explosives used in radiological dispersion devices aboard waterborne vessels. The detection methodology happens to be sensitive to drugs as well. The system includes an accelerator mounted on a floating platform such as a ship. The accelerator directs a photon beam of a specific energy at a waterborne target vessel, and if the target vessel contains special nuclear materials, explosives, or drugs, photonuclear reactions induced by the photon beam will produce neutrons from such materials onboard the ship. Neutron detectors (e.g., He-3 tubes) mounted on the floating platform can detect the neutron radiation from the target vessel. Neutron radiation induced by the accelerator is detectable even through shielding such as lead. The invention can determine not only the presence of special nuclear materials, explosives and drugs aboard the target vessel but also the approximate location of any such material within the vessel.

The neutron detectors may be supplemented by gamma radiation detectors to detect radioactive material that might be present through its direct gamma radiation signal.

In one embodiment, a floatation stabilization system supports the floating platform and works in conjunction with a targeting system to control and aim the photon beam from the accelerator.

A data storage system documents the measured radiation signal and corresponding identification data for the target vessel and can access a database containing the target vessels cargo manifest. Video cameras may be used to identify the target vessel. The radiation and identification data along with GPS data can be sent in near real time to the appropriate authorities via secure data transmission.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 illustrates the phenomenon of bremsstrahlung radiation;

FIG. 2 illustrates photoneutron emission and fission of fissile material produced by bremsstrahlung radiation;

FIGS. 3A and 3B show a fissile material detection system in accordance with the present invention;

FIG. 4 shows the detection system mounted onto a waterborne vessel in accordance with the present invention; and

FIG. 5 is a block diagram of the detection system in accordance with the present invention.

### DETAILED DESCRIPTION OF THE DRAWINGS

The present invention provides a platform for scanning any vessel at high seas to detect and identify weapons of mass destruction and material which can be used as a mass destruction weapon. The main area of concentration is on detecting and identifying any fissile material (i.e. special nuclear materials, highly enriched uranium) and explosives. It is also possible to detect drugs with a high nitrogen content using the present methodology.

The present invention relies on a linear accelerator based, photonuclear interrogation. A linear accelerator is used to produce bremsstrahlung radiation, which is emitted when charged particles (i.e. electrons) are decelerated over a very short distance, such as passing through a field of atomic nuclei.

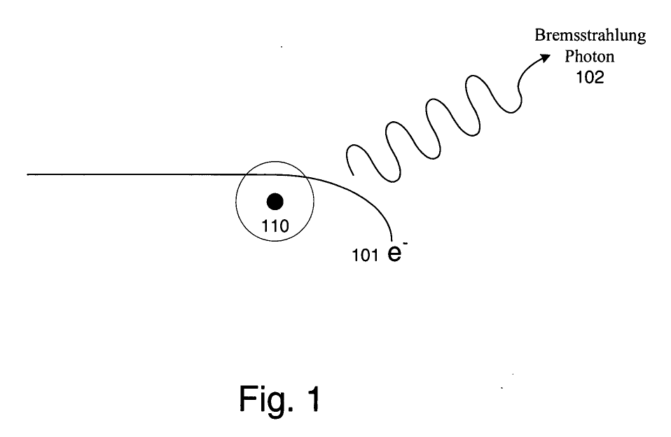

FIG. 1 illustrates the phenomenon of bremsstrahlung radiation. The deceleration of the electrons that causes the emission of bremsstrahlung photons comes from deflection of the electrons' path due to electrostatic attraction between the negatively charged electron and the positively charged protons in the nucleus. As the electron 101 approaches the nucleus of an atom 110 its velocity increases and then decreases as it moves away from the nucleus. This rapid acceleration and deceleration produces electromagnetic radiation 102 equal to the change in kinetic energy of the electron, producing a continuous spectrum with a characteristic profile and energy cutoff (i.e. wavelength minimum). The production of bremsstrahlung radiation increases with the atomic number of the target atom.

The minimum possible wavelength of bremsstrahlung radiation is given as:

$${λ}_{min} = \frac{hc}{e V}$$

where

h is Planck's constant

c is the speed of light

e is the charge on the electron

V is the voltage change

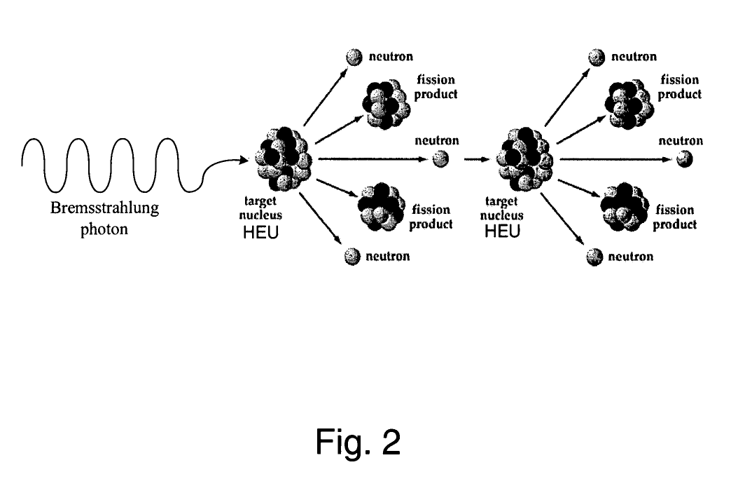

The photons from the bremsstrahlung radiation interact with the nuclei of the target to produce neutrons by photonuclear reactions as illustrated in FIG. 2. In the case of fissile material (e.g., highly enriched uranium (HEU)), the bremsstrahlung photons and photoneutrons induce nuclear fissions, which produce prompt and delayed neutron emissions that can be detected even if the fissile material is shielded. These emitted neutrons can be detected using neutron sensitive radiation detectors such as Helium-3 detectors, which are well known in the art.

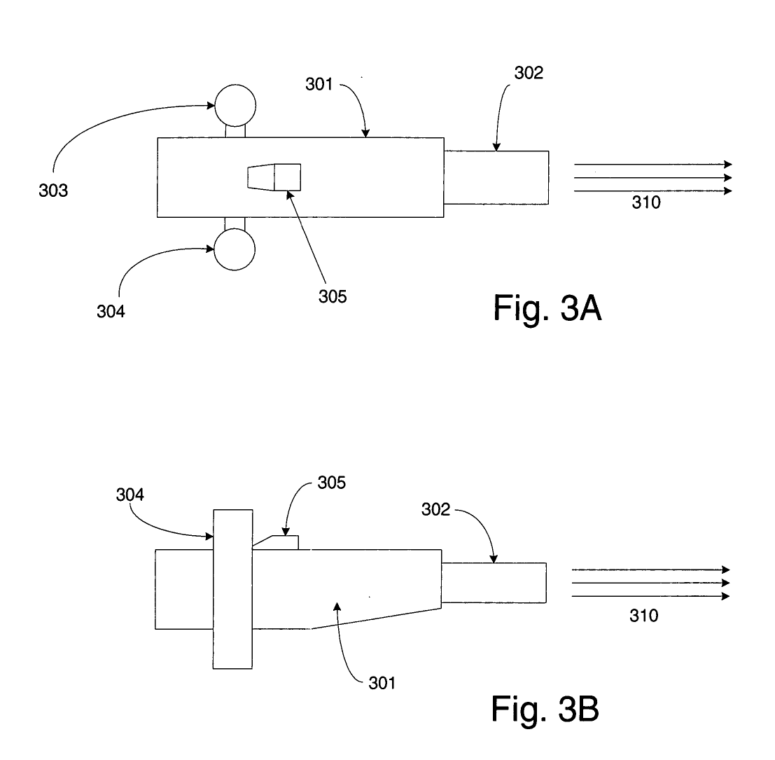

FIGS. 3A and 3B show a fissile material detection system in accordance with the present invention. FIG. 3A shows a top plan view of the system, while FIG. 3B shows a side view. The heart of the detection system is a linear accelerator 301 and beam collimator 302, which produces a high energy beam of photons 310. It is this photon beam that produces the photonuclear reactions in any fissile material or explosives that may be present aboard a target vessel.

The chief advantage of incorporating an active component like the linear accelerator into the detection system is circumvention of shielding that may be hiding smuggled nuclear device with its special nuclear material or the explosives surrounding a possible radiological dispersion device (RDD). If the nuclear device or the radiological dispersion device is surrounded by heavy shielding (i.e. lead), traditional passive detection systems might be unable to detect the radiation emitted from the material. However, the characteristic neutron emissions resulting from photonuclear reactions induced by the linear accelerator will easily pass through such shielding.

The linear accelerator 301 is based on commercially available technology. This is another advantage since linear accelerator technology is well known and provides publicly accepted levels of photon energy that are routinely used in medical and industrial applications. The present invention can induce the necessary photonuclear reactions in fissile material or explosives with photon beam energy of 6-11 MeV.

In the specific example illustrated in FIGS. 3A and 3B, neutron sensitive radiation detectors 303, 304 (e.g. Helium-3 tubes) are placed on each side of the linear accelerator 301 to detect neutrons emitted from the vessel being interrogated. Additional detectors of the same kind further away from the accelerator will provide a more efficient detection mechanism. In addition to Helium-3 tubes, the present invention may also be implemented using any neutron detection device that can be built in large quantities and in reasonably large size. Each detector type obviously has its own characteristics, and the exact implementation may vary some in details depending on which neutron detector type is used.

If necessary, a gamma radiation sensitive detectors 305 (e.g. Germanium (Ge) detector) either near the accelerator or in various places further away can be deployed along with the neutron detectors 303, 304 to detect any gamma radiation created by the nuclear reactions induced by the high energy photons from the linear accelerator in addition to gamma radiation emitted by generally radioactive materials in the vessel being interrogated. Other detector, such as Nal, CsI, BGO, etc. may also be used with the present invention, although they do not have the same resolution and specificity as a germanium detector. However, these other detector types do not require cooling to operate. Again, the implementation details of the method will vary depending on which detector type is chosen for the implementation and the needs and resources of the user.

The invention is able to detect all radioactive materials that emit gamma radiation without the use of the linear accelerator. The gamma detectors 305 mounted on the accelerator, or elsewhere on the interrogating ship, are sensitive to any radiation present. Conclusions can be drawn from the radiation signature that such detectors observe. The germanium detectors have the best specificity when paired with software, but the other detectors mentioned above have identification capabilities as well when used in conjunction with the right analysis methods known in the art. In addition, the neutron detectors 303, 304 are capable to detecting any neutrons that might be emitted by the target vessel without it being interrogated by the accelerator beam.

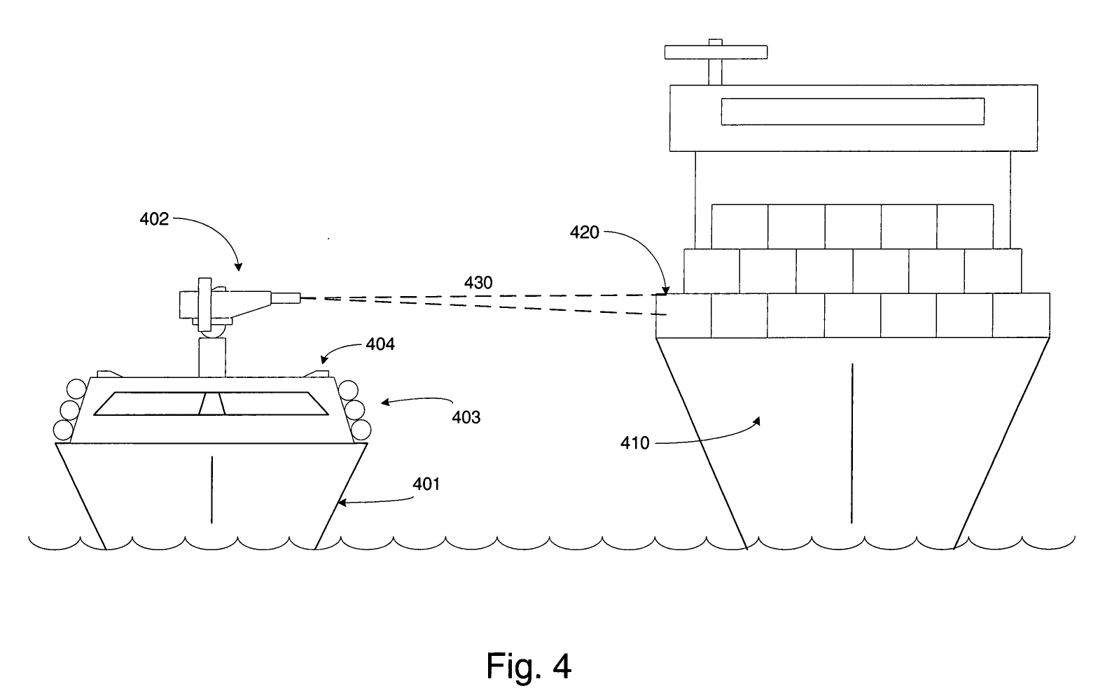

FIG. 4 shows the detection system mounted onto a waterborne vessel in accordance with the present invention. The inspection vessel 401 is able to intercept and inspect incoming cargo vessels 410 at sea before they approach the coastline. Once the inspected vessel is scanned by a linear accelerator beam 430, if there is fissile material in the cargo 420, even if shielded it will start emitting neutrons which would be detected by the neutron radiation detectors 403 mounted on the inspection ship 401.

In one embodiment of the invention, the neutron radiation detectors mounted on the linear detector may be supplemented by banks of additional detectors 403. Similarly, additional gamma radiation detectors 404 may also be arrayed on the inspection vessel 401. Data generated from the radiation detectors includes not only the presence of fissile material and/or explosives but also its extrapolated quality and quantity.

The operation of the detection system on the inspection vessel 401 is supported by a stabilization system. This stabilization system may be based on technology known in the art such as a Rudder Roll Stabilization (RSS), which uses the rudders to compensate for wind- and wave-induced roll motions. The RRS makes motion-sensitive operational tasks possible for a substantially larger percentage of time under heavy sea conditions. Within the context of the inspection vessel of the present invention 401, the stabilization system allows for accurate targeting of the linear accelerator 402 and detectors 403, 404.

The present invention can determine whether or not fissile or radioactive material or explosives in general is on board of the inspected vessel, as well as the approximate location where the material in question is located within the vessel. The ability to approximate the location of fissile material or explosives about the inspected vessel 410 is important since the vessel in question may often be a cargo vessel with a large payload. The invention also resolves the complicated issue of scanning bulk (non-containerized) cargo ships and tankers.

Depending on the energy of the linear accelerator beam, the system may also be able to detect conventional explosives. Similar to the detection of fissile material, photonuclear reactions in conventional explosives induce neutrons from the interrogated target. The photoneutron threshold for nitrogen (the principal element in explosive and many illicit drugs) requires photon beam energy of 10.5 MeV.

In addition to detecting radioactive material and/or explosives, the present invention also acquires video image of the exterior of the inspected vessel and identifying markers. The inspected vessel 410 is monitored by video cameras (not shown) mounted on the inspection vessel 401. If cargo containers are equipped with radio frequency (RF) or comparable seals, the present invention can retrieve the most current data from such seals. This information can be combined with video data to identify the cargo, the vessel, and other information elements and then correlated with the manifest and cargo list of the suspect vessel.

The scan data and identification information are grouped with video and Global Positioning System (GPS) data and time stamped. This grouped data can be transmitted in near real time to all the appropriate operators on shore, including appropriate Customs officials, ship operators, owners, cargo recipient, port authorities, Coast Guard, Navy, etc. The data may also be transmitted in near real time to authorities at the vessel's point of origin, facilitating coordination of international investigations with a minimum of delay. Independently working secure data transmission equipment supports the entire system.

Therefore, the inspection vessel of the present invention acts not merely as a weapon detection system but also as an information hub for military and law enforcement agencies.

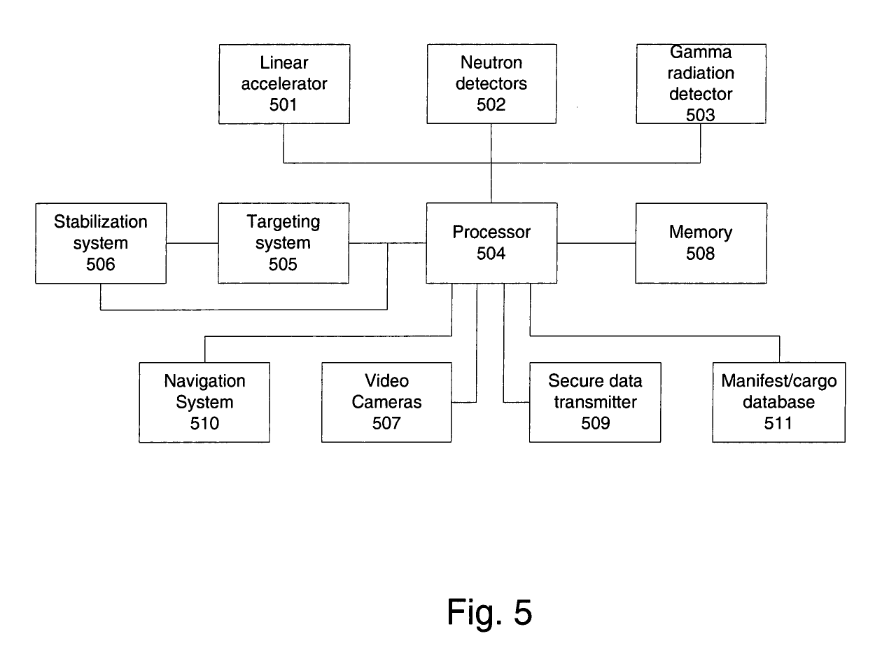

FIG. 5 is a block diagram of the detection system in accordance with the present invention. Data from the linear accelerator 501, neutron detectors 502, and gamma detectors 503 is fed to a processor 504 and stored in memory 508. The targeting system 505 and ship stabilization system 506 work in conjunction to help the processor 504 accurately control the operation of the linear accelerator 501 and detectors 502, 503. Various targeting systems are known in the art for both military and civilian applications and can be applied to the present invention.

Video cameras 507 provide identifying data about the inspected vessel, while a navigation system 510 provides information about the vessel's location.

The secure data transmitter 509 allows relevant information about the inspected vessel to be sent in real time directly to military and law enforcement authorities, as well as other relevant parties as described above. Information about the manifest and cargo list of the identified suspect vessel may be stored in a local database 511 on the inspection vessel or may be obtained from a remote database via the secure data transmitter 509.

By conducting cargo screening hundreds of miles away from the shore, the present invention avoids dealing with radioactive and fissile materiel on territorial land. This allows the detection of nuclear weapons before they reach a distance from land that is within their blast radius, thus minimizing casualties in a worst case scenario. Therefore, in addition to improving the detection of fissile material, the invention also enables the enforcement of an extended security perimeter around coastal territory. From the standpoint of safety for military and coastal defense personnel, the present invention does not require actual boarding of the inspected vessel.

Though the above discussion has focused on the specific problem of vessels carrying containerized cargo, it should be emphasized that the present invention can scan any vessel. There are risks other than dedicated cargo vessels. For example, there is a clear risk that a pleasure boat might have a nuclear load that can be detonated close to the embankment. Also mentioned briefly above, there are a number of bulk vessels which are impossible to process by a shore-based system as found in the prior art. The present invention can scan any vessel at any location.

Because the present invention is non-intrusive and can scan an entire vessel in one pass, it simplifies the logistics of cargo scanning and inspection. Thus the present invention actually speeds up the flow of commerce since there is no need to manually inspect (scan) individual containers on shore. It also significantly reduces the cost per container (or per vessel) scanned versus “traditional” x-ray or gamma ray systems, supported by radiation sensors applied on the coast.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim:

1. A system for detecting explosive, radioactive or fissile material aboard waterborne vessels, the system comprising:
(a) a floating platform;
(b) at least one linear accelerator coupled to said floating platform, wherein the linear accelerator can direct a photon beam at a waterborne target vessel, wherein if said target vessel contains explosive, radioactive or fissile material, photonuclear reactions induced by the photon beam will produce characteristic neutron radiation from the explosive, radioactive or fissile material, wherein said neutron radiation is detectable through shielding;
(c) at least one neutron radiation detector coupled to said floating platform for detecting said induced neutron radiation if said target vessel contains explosive, radioactive or fissile material; and
(d) a data storage system for documenting radiation data and corresponding identification data for the target vessel.

2. The system according to claim 1, wherein the floating platform of part (a) is a ship.

3. The system according to claim 1, wherein the floating platform of part (a) further comprises a floatation stabilization system.

4. The system according to claim 3, wherein the stabilization system works in conjunction with a targeting system that controls the linear accelerator.

5. The system according to claim 1, further comprising:
(e) at least one gamma radiation detector.

6. The system according to claim 1, wherein the neutron radiation detection in part (c) is a Helium-3 tube.

7. The system according to claim 1, wherein the data storage system in part (d) further comprises means for accessing a cargo manifest of the target vessel.

8. The system according to claim 1, further comprising:
(f) at least one video camera for recording visual information about the target vessel and recording it in the data storage system in part (d).

9. The system according to claim 1, further comprising:
(g) a secure data transmitter for sending data from the data storage system in part (d) to designated authorities.

10. The system according to claim 9, wherein the data sent to the authorities includes GPS data.

11. The system according to claim 1, wherein the system can also determine the approximate location of any explosive, radioactive or fissile material present on the target vessel.

12. The system according to claim 1, wherein the target vessel contains containerized cargo.

13. The system according to claim 1, wherein the target vessel contains non-containerized bulk cargo.

14. The system according to claim 1, wherein the photon beam has energy of between 6-11 MeV.
